(19) United States
(12) Patent Application Publication
(10) Pub. No.: US 2008/0309219 A1
(43) Pub. Date: Dec. 18, 2008

(54) PHOSPHORS AND LIGHTING APPARATUS USING THE SAME

(76) Inventors: Teng-Ming CHEN, Hsinchu City (TW); Yi-Chun Chou, Hsinchu City (TW)

Correspondence Address: SINORICA, LLC, 528 FALLSGROVE DRIVE, ROCKVILLE, MD, 20850, US

(21) Appl. No.: 12/061,563

(22) Filed: Apr. 2, 2008

(30) Foreign Application Priority Data
Jun. 12, 2007 (TW) 096129502

(51) Int. Cl. H01J 1/62; C01F 17/00

(52) U.S. Cl. 313/501; 423/263

(57) ABSTRACT

A phosphor has a chemical formula of: A(B₁₋ₘEuₘ²+)PO₄, wherein A is at least one of the group consisting of Li, Na and K, and B is at least one of the group consisting of Ca, Sr and Ba, and 0.0001≦m≦0.8.

### BACKGROUND OF THE INVENTION

1. Technical Field

The present invention relates to phosphors and, more particularly, to phosphors to be used in a lighting apparatus.

2. Description of Related Art

Semiconductor lighting apparatuses include light-emitting diodes (LEDs) and laser diodes. Semiconductor lighting apparatuses which provide ultraviolet or near ultraviolet light can be used in combination with different phosphors to make various kinds of light sources.

Of all the new products in the LED industry, white light-emitting diodes are the most promising ones because they provide such advantages as having a small size, low heat generation, low power consumption and a long service life. Therefore, white light-emitting diodes can be used to replace fluorescent lamps and back lights of flat-panel displays. The so-call “white light” is in fact a combination of various color lights. A white light visible to human eyes must comprise a combination of at least two color lights, such as a combination of blue and yellow lights or a combination of green, blue and red lights.

Nowadays, a plurality of green phosphors can be used as wavelength-converting phosphors in LEDs. Among those, the most frequently used green phosphors are (Ba,Ca,Sr)MgAl₁₀O₁₇:Eu²⁺,Mn²⁺ (abbreviated as BAM:Eu,Mn), (Ca,Sr,Ba)Al₂O₄:Eu²⁺, (Mg, Ca,Sr,Ba)₃Si₂O₇:Eu²⁺ and Ca₈Mg(SiO₄)₄Cl₂:Eu²⁺,Mn²⁺, all of which have a high color purity and high light-emitting efficiency. In addition, BaAl₁₂O₁₉:Mn²⁺, which also has a high color purity, is another alternative of green phosphors (S. Shionoya and W. M. Yen, Phosphor Handbook, Chap. 10, CRC Press, Boca Raton, Fla. (1998)).

Presently, new phosphors can be made and brightness of green phosphors can be increased by adding appropriate rare earth ions or ions of transition metals. Taking SrAl₁₂O₁₉:Eu²⁺,Mn²⁺ (Philips Technical Review, 37 (1977) pp. 221-233) for example, Eu²⁺ is excited to emit blue light, which in turn is used to excite Mn²⁺, so as to provide a green light of high intensity and to shorten the phosphor decay cycle.

### SUMMARY OF THE INVENTION

A primary objective of the present invention is to provide a series of phosphors having novel compositions.

A second objective of the present invention is to provide a series of phosphors to be used in a lighting apparatus, wherein the phosphors provide a broadband radiation source of green light.

A third objective of the present invention is to provide a series of phosphors having novel compositions, for use in a white light-emitting apparatus in combination with red phosphors and blue phosphors.

To achieve these objectives, the present invention provides a phosphor having the general formula: A(B₁₋ₘEuₘ²⁺)PO₄, wherein A is at least one of the group consisting of Li, Na and K; B is at least one of the group consisting of Ca, Sr and Ba; and 0.0001≦m≦0.8.

The present invention further provides a lighting apparatus comprising a semiconductor light source and a phosphor, wherein the phosphor has the general formula: A(B₁₋ₘEuₘ²⁺)PO₄, wherein A is at least one of the group consisting of Li, Na and K; B is at least one of the group consisting of Ca, Sr and Ba; and 0.0001≦m≦0.8.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 shows X-ray powder diffraction patterns of two phosphors, namely, Na(Ca_{0.995}Eu_{0.005})PO₄ and K(Ca_{0.995}Eu_{0.005})PO₄, according to a preferred embodiment of the present invention;

FIG. 2 is the excitation and emission spectra of Na(Ca_{0.995}Eu_{0.005})PO₄ according to the preferred embodiment of the present invention;

FIG. 3 is the excitation and emission spectra of K(Ca_{0.995}Eu_{0.005})PO₄ according to the preferred embodiment of the present invention;

FIG. 4 shows a comparison of excitation and emission spectra between Na(Ca_{0.995}Eu_{0.005})PO₄ according to the preferred embodiment of the present invention and LP-G3 (BAM:Eu²⁺,Mn²⁺);

FIG. 5 shows a comparison between emission spectra of Na(Ca_{0.995}Eu_{0.005})PO₄ according to the preferred embodiment of the present invention and LP-G3 (BAM:Eu²⁺,Mn²⁺);

FIG. 6 shows another comparison of emission spectra between Na(Ca_{0.995}Eu_{0.005})PO₄ according to the preferred embodiment of the present invention and LP-G3 (BAM:Eu²⁺,Mn²⁺);

FIG. 7 shows a comparison of chromaticity coordinates among Na(Ca_{0.995}Eu_{0.005})PO₄ and K(Ca_{0.995}Eu_{0.005})PO₄ according to the preferred embodiment of the present invention and LP-G3 (BAM:Eu²⁺,Mn²⁺);

FIG. 8 is a plot showing a relationship among luminance, relative brightness and a doping concentration of Eu²⁺, for a series of phosphors according to the present invention; and

FIG. 9 shows a comparison of diffuse reflection spectra between Na(Ca_{0.995}Eu_{0.005})PO₄ according to the preferred embodiment of the present invention (which is doped with Eu²⁺) and a matrix thereof (i.e., NaCaPO₄, which is not doped with Eu²⁺).

### DETAILED DESCRIPTION OF THE PREFERRED EMBODIMENT

A detailed description of the present invention will be given below with reference to a preferred embodiment thereof, so that a person skilled in the art can readily understand the features and functions of the present invention after reviewing the contents disclosed herein. The present invention can be carried out or applied in other embodiments, where changes and modifications can be made to the details disclosed herein from a viewpoint different from that adopted in this specification within the scope and spirit of the present invention.

A phosphor according to the present invention is prepared through solid-state reaction at a high temperature. A preferred embodiment of the present invention is Na(Ca₁₋ₘEuₘ²⁺)PO₄, which is prepared by a method comprising the following steps. To begin with, calcium carbonate (CaCO₃), sodium carbonate (Na₂CO₃), europium sesquioxide (Eu₂O₃) and diammomium hydrogen phosphate ((NH₄)₂HPO₄) are weighed stoichiometrically, thoroughly mixed and then ground for ten minutes. Then the resultant mixture is put into a crucible and placed in a high-temperature furnace to be sintered in a reduction atmosphere at approximately 800 to 1200° C. for several hours. The final product is the phosphor according to the preferred embodiment of the present invention, i.e., Na(Ca₁₋ₘEuₘ²⁺)PO₄, wherein 0.0001≦m≦0.8.

In the steps described above, calcium carbonate (CaCO₃) can be replaced by various metal carbonates, such as strontium carbonate (SrCO₃) or barium carbonate (BaCO₃), while sodium carbonate (Na₂CO₃) can be replaced by various alkaline carbonates, such as lithium carbonate (Li₂CO₃) or potassium Carbonate (K₂CO₃). The various phosphors of the present invention can be prepared by using different metal salts.

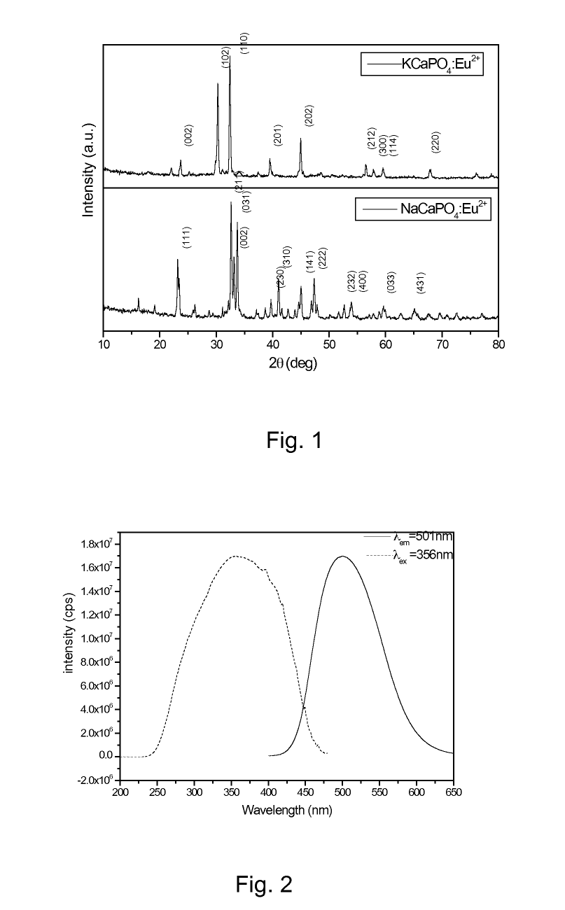

The above-mentioned method was used to prepare Na(Ca_{0.995}Eu_{0.005})PO₄ and K(Ca_{0.995}Eu_{0.005})PO₄, whose X-ray powder diffraction patterns are shown in FIG. 1. According to the results of crystalline phase analysis using X ray diffraction, these two matrices synthesized according to the present invention are single-phased phosphors and no impurities were found therein.

Referring to FIG. 2, a spectrofluorometer was used to produce an excitation and emission spectrum of Na(Ca_{0.995}Eu_{0.005})PO₄, which was prepared according to the preferred embodiment of the present invention. It is shown that Na(Ca_{0.995}Eu_{0.005})PO₄ of the present invention exhibits a very broad absorption band ranging from an ultraviolet zone through a near-ultraviolet zone to a blue light zone. Furthermore, Na(Ca_{0.995}Eu_{0.005})PO₄ has a major emission peak at a wavelength of approximately 501 nm, and an emission band spanning approximately 200 nm. It is therefore proved that the phosphor according to the present invention can be excited by an ultraviolet, near-ultraviolet or blue light. The wavelength of the excitation light ranges from about 280 nm to about 450 nm, so as to induce the phosphors to emit a green light having a luminance of 10⁷ cps or higher.

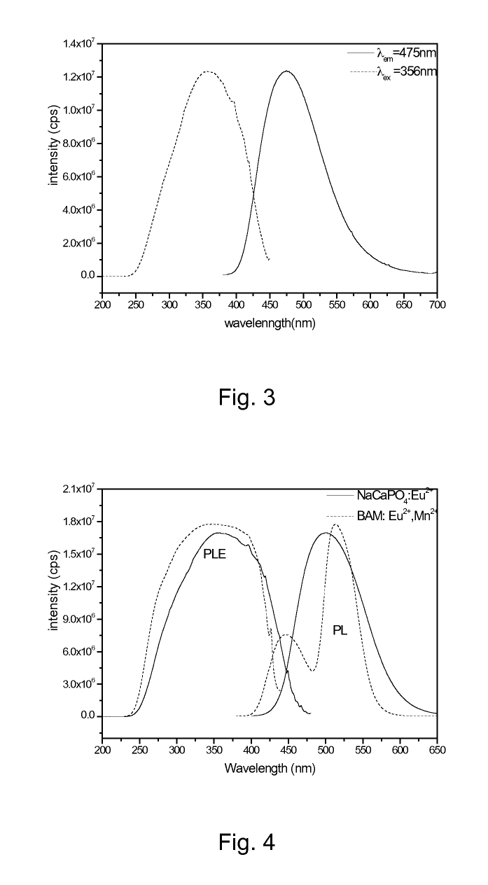

Referring to FIG. 3, the spectrofluorometer was also used to produce an excitation and emission spectrum of K(Ca_{0.995}Eu_{0.005})PO₄, which was prepared according to the preferred embodiment of the present invention. As shown in FIG. 3, K(Ca_{0.995}Eu_{0.005})PO₄ of the present invention also has a very broad absorption band ranging from an ultraviolet zone through a near ultraviolet zone to a blue light zone. In this embodiment, the phosphor has a major emission peak at a wavelength of approximately 475 nm, and has a luminance of 10⁷ cps or higher.

It can be known from FIGS. 2 and 3 that the phosphors of the present invention have major emission peaks at wavelengths ranging from about 475 nm to about 501 nm, emission bands spanning about 450 nm to about 600 nm, and luminance of 10⁷ cps or higher.

FIG. 4 provides a comparison of photoluminescence and excitation spectra between Na(Ca_{0.995}Eu_{0.005})PO₄ synthesized according to the present invention and LP-G3 (BAM:Eu²⁺,Mn²⁺), a product from Kasei Optonix, which is a Japanese phosphor company. It is shown in FIG. 4 that the phosphor of the present invention has a broader excitation band around a blue light zone than LP-G3 (BAM:Eu²⁺,Mn²⁺), and a luminance similar to that of LP-G3. Therefore, Na(Ca_{0.995}Eu_{0.005})PO₄ of the present invention can be advantageously applied to blue light-excited diodes.

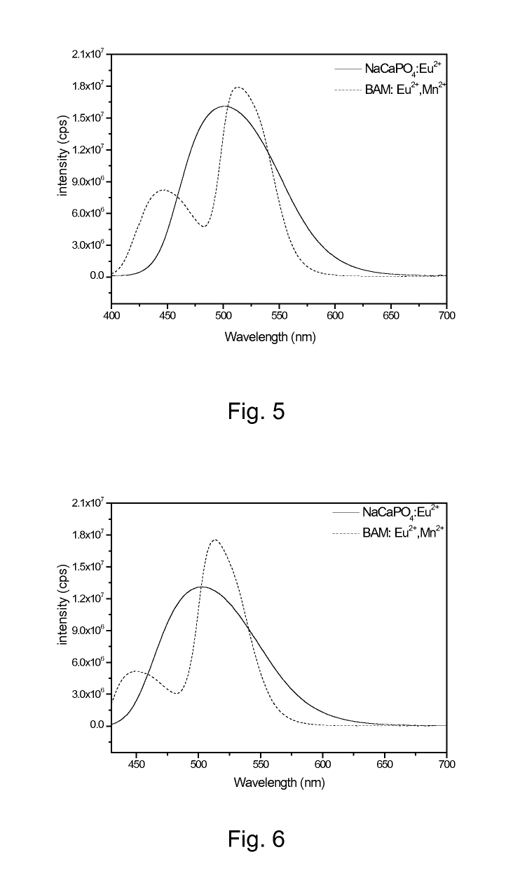

Now that commercially available ultraviolet LED chips generally have an excitation wavelength of about 365 nm, Na(Ca_{0.995}Eu_{0.0005})PO₄ according to the present invention and LP-G3 (BAM:Eu²⁺,Mn²⁺) from Kasei Optonix were both excited by a light having a wavelength of 365 nm for a comparison of emission spectra between the two phosphors, as shown in FIG. 5. Compared with LP-G3, the phosphor of the present invention has an emission band covering a wider range of wavelengths, a similar brilliance (an area integral of the emission band) and a higher quantum efficiency.

Furthermore, commercially available near ultraviolet LED chips of today generally have an excitation wavelength of about 400 nm. Therefore, Na(Ca_{0.995}Eu_{0.005})PO₄ of the present invention and LP-G3 (BAM:Eu²⁺,Mn²⁺) from Kasei Optonix were both excited by a light having a wavelength of 400 nm to compare the emission spectra of the two phosphors, as shown in FIG. 6. It is found that, compared with LP-G3, the phosphor of the present invention provides a similar luminance and yet an emission band covering a wider range of wavelengths. Moreover, while the phosphor of the present invention has a brilliance (an area integral of the emission band) similar to that of LP-G3, the former has a higher quantum efficiency.

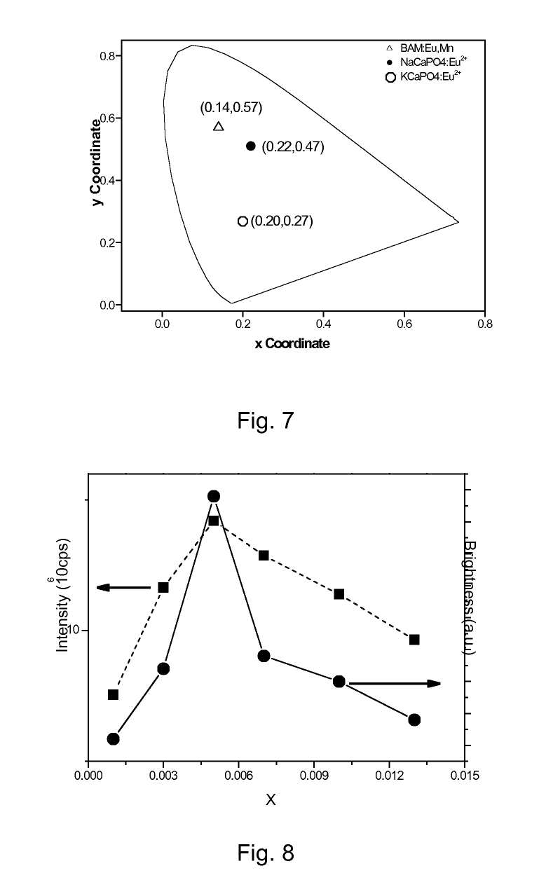

FIG. 7 is a chromaticity diagram in which the chromaticity coordinates of Na(Ca_{0.995}Eu_{0.005})PO₄ and K(Ca_{0.995}Eu_{0.005})PO₄ synthesized according to the present invention are compared with that of LP-G3 (BAM:Eu²⁺,Mn²⁺) from Kasei Optonix. The chromaticity coordinates of Na(Ca_{0.995}Eu_{0.005})PO₄ and K(Ca_{0.995}Eu_{0.005})PO₄ are (0.22, 0.47) and (0.20, 0.46), respectively. Na(Ca_{0.995}Eu_{0.005})PO₄ has a chromaticity similar to that of LP-G3 (BAM:Eu²⁺,Mn²⁺) and emits a blue-green light.

FIG. 8 is a plot showing the relationship among luminance, relative brilliance and a doping concentration of Eu²⁺, for Na(Ca₁₋ₘEuₘ²⁺)PO₄ according to the preferred embodiment of the present invention, wherein the doping concentration of Eu²⁺ ranges from about 0.001 to about 0.01. It is shown that the phosphor has the highest luminance and brilliance when the doping concentration of Eu²⁺ is around 0.005.

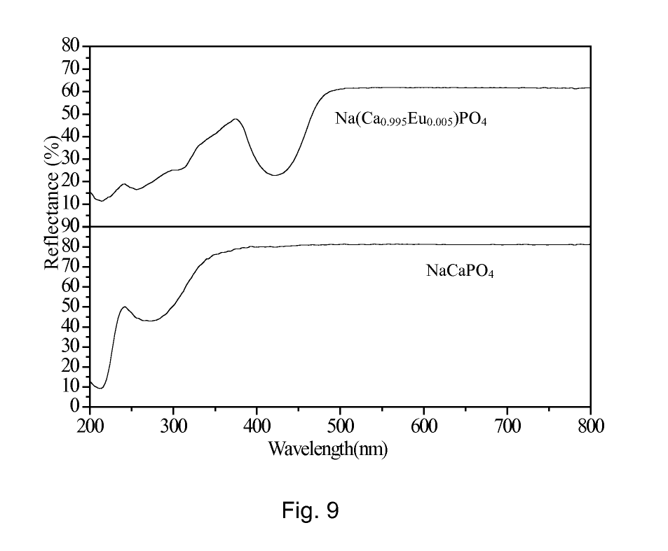

FIG. 9 provides a comparison of diffuse reflection spectra between Na(Ca_{0.995}Eu_{0.005})PO₄ according to the present invention and NaCaPO₄, a matrix of said phosphor, for determining an absorption band of Na(Ca_{0.995}Eu_{0.005})PO₄ of the present invention. It is shown that, without being doped with Eu²⁺, NaCaPO₄ absorbs radiation having a wavelength ranging only from about 200 nm to 230 nm, which is the absorption band of the matrix. With Eu²⁺ doped, it is found that Na(Ca_{0.995}Eu_{0.005})PO₄ has a very broad absorption band ranging from about 230 nm to about 450 nm. Therefore, it is proved that the phosphor Na(Ca_{0.995}Eu_{0.005})PO₄ is capable of effectively absorbing an ultraviolet light, near-ultraviolet light and blue light.

The phosphors according to the present invention can be applied to a lighting apparatus comprising a semiconductor light source such as a light-emitting diode or a laser diode, wherein the semiconductor light source emits an ultraviolet light, a near ultraviolet light or a blue light. The lighting apparatus can emit a green light when the semiconductor light source is used in combination with the phosphors of the present invention.

The lighting apparatus may further comprise a red phosphor and a blue phosphor in order to emit a white light or a light similar to a white light, wherein the red phosphor can be (Sr, Ca)S:Eu²⁺; (Y,La,Gd,Lu)₂O₃:Eu³⁺,Bi³⁺; (Y,La,Gd,Lu)₂O₂S:Eu³⁺,Bi³⁺; Ca₂Si₅N₈:Eu²⁺ or ZnCdS:AgCl; while the blue phosphor can be BaMgAl₁₀O₁₇:Eu²⁺.

In summary, the phosphors according to the present invention have not only novel compositions but also broad excitation ranges (from an ultraviolet zone to a blue light zone), and can therefore be used in combination with commercially available ultraviolet LED chips. Furthermore, the phosphors according to the present invention provide a luminescence intensity of 10⁷ cps or higher, and are therefore suitable to be incorporated into various lighting apparatuses. Particularly, the phosphor according to the present invention is applicable to a white light-emitting apparatus when used in combination with a red phosphor and a blue phosphor.

The preferred embodiment of the present invention has been provided for illustrative purposes only and is not intended to limit the scope of the present invention in any way. It is understood that all simple modifications and equivalent structural alterations made to the present invention according to the content and drawings of this specification are encompassed by the appended claims.

What is claimed is:

1. A phosphor, having a chemical formula of:
A(B₁₋ₘEuₘ²⁺)PO₄;
wherein A is at least one of the group consisting of Li and Na, and B is at least one of the group consisting of Ca, Sr and Ba, while 0.0001≦m≦0.8.

2. The phosphor as claimed in claim 1, wherein 0.001≦m≦0.01.

3. The phosphor as claimed in claim 1, wherein the phosphor can be excited by a radiation source having a wavelength ranging from about 280 nm to about 450 nm.

4. The phosphor as claimed in claim 3, wherein the phosphor has an emission wavelength ranging from about 450 nm to about 600 nm.

5. The phosphor as claimed in claim 1, wherein the phosphor has a CIE coordinate comprising an x-coordinate ranging from about 0.20 to 0.23 and a y-coordinate ranging from about 0.46 to 0.48.

6. The phosphor as claimed in claim 1, wherein the phosphor has a luminescence intensity of 10⁷ cps or higher.

7. A phosphor, having a chemical formula of:
K(B₁₋ₘEuₘ²⁺)PO₄;
wherein B is at least one of the group consisting of Ca and Ba; and 0.0001≦m≦0.8.

8. The phosphor as claimed in claim 7, wherein 0.001≦m≦0.01.

9. The phosphor as claimed in claim 7, wherein the phosphor can be excited by a radiation source having a wavelength ranging from about 280 nm to about 450 nm.

10. The phosphor as claimed in claim 9, wherein the phosphor has an emission wavelength ranging from about 450 nm to about 600 nm.

11. The phosphor as claimed in claim 7, wherein the phosphor has a CIE coordinate comprising an x-coordinate ranging from about 0.20 to 0.23 and a y-coordinate ranging from about 0.46 to 0.48.

12. The phosphor as claimed in claim 7, wherein the phosphor has a luminescence intensity of 10⁷ cps or higher.

13. A lighting apparatus comprising a semiconductor light source and a phosphor, which has a chemical formula of:
A(B₁₋ₘEuₘ²⁺)PO₄;
wherein A is at least one of the group consisting of Li and Na, and B is at least one of the group consisting of Ca, Sr and Ba, while 0.0001≦m≦0.8.

14. The lighting apparatus as claimed in claim 13, wherein m is 0.005.

15. The lighting apparatus as claimed in claim 13, further comprising a red phosphor and a blue phosphor.

16. The lighting apparatus as claimed in claim 15, wherein the red phosphor comprises (Sr, Ca)S:Eu²⁺ (Y,La,Gd,Lu)₂O₃:Eu³⁺,Bi³⁺;
(Y,La,Gd,Lu)₂O₂S:Eu³⁺,Bi³⁺; Ca₂Si₅N₈:Eu²⁺ or ZnCdS:AgCl.

17. The lighting apparatus as claimed in claim 15, wherein the blue phosphor comprises BaMgAl₁₀O₁₉:Eu²⁺.

18. A lighting apparatus comprising a semiconductor light source and a phosphor, which has a chemical formula of:
K(B₁₋ₘEuₘ²⁺)PO₄;
wherein B is at least one of the group consisting of Ca and Ba; and 0.0001≦m≦0.8.

19. The lighting apparatus as claimed in claim 18, wherein m is 0.005.

20. The lighting apparatus as claimed in claim 18, further comprising a red phosphor and a blue phosphor.

21. The lighting apparatus as claimed in claim 20, wherein the red phosphor comprises (Sr, Ca)S:Eu²; (Y,La,Gd,Lu)₂O₃:Eu³⁺,Bi³⁺;
(Y,La,Gd,Lu)₂O₂S:Eu³⁺,Bi³⁺; Ca₂Si₅N₈:Eu²⁺ or ZnCdS:AgCl.

22. The lighting apparatus as claimed in claim 20, wherein the blue phosphor comprises BaMgAl₁₀O₁₉:Eu²⁺
